(19) United States
(12) Patent Application Publication
(10) Pub. No.: US 2002/0147663 A1
(43) Pub. Date: Oct. 10, 2002

(54) Systems and methods for facilitating a transaction by use of third party subsidies

(76) Inventors: Jay S. Walker, Ridgefield, CT (US); Andrew S. Van Luchene, New York, NY (US); Stephen C. Tulley, Fairfield, CT (US); Magdalena M. Fincham, Norwalk, CT (US); Daniel E. Tedesco, Huntington, CT (US); Wen Yan Lin, New York, NY (US)

Correspondence Address: WALKER DIGITAL, FIVE HIGH RIDGE PARK, STAMFORD, CT, 06905, US

(21) Appl. No.: 10/100,685

(22) Filed: Mar. 15, 2002

Related U.S. Application Data
(63) Continuation-in-part of application No. 09/540,034, filed on Mar. 31, 2000.
(60) Provisional application No. 60/276,196, filed on Mar. 15, 2001.

(51) Int. Cl. G06F 17/60

(52) U.S. Cl. 705/26

(57) ABSTRACT

Systems and methods are provided to process a transaction in which a customer purchases an item. A third party subsidy offer, such as an offer to apply a third party subsidy amount to the transaction in exchange for the customer performing a task, is provided to the customer. The third party subsidy offer may be provided to the customer in response to the customer indicating an interest in purchasing the item. An evaluation may be performed to determine if a merchant benefit, such as a merchant subsidy amount, will also be applied to the transaction. A further evaluation may be performed to determine whether an additional task, not corresponding to a benefit, will also be associated with the third party subsidy offer and also output to the customer in conjunction with, or as part of, the third party subsidy offer.

### CLAIM OF PRIORITY TO OTHER APPLICATIONS

The present application is a continuation-in-part application of (i) U.S. patent application Ser. No. 09/540,034 entitled SYSTEMS AND METHODS WHEREIN A THIRD PARTY SUBSIDY AND A MERCHANT SUBSIDY FACILITATE A TRANSACTION, filed Mar. 31, 2000 in the name of Walker et al.; and (ii) U.S. Provisional Application Serial No. 60/276,196 entitled METHODS AND APPARATUS FOR EFFECTUATING DISCOUNT PRICING, filed Mar. 15, 2001 in the name of Walker et al. The entirety of each of the above-reference applications is incorporated by reference herein.

### CROSS-REFERENCES TO RELATED APPLICATIONS

The present application is related to: U.S. patent application Ser. No. 09/282,747 entitled “Method and Apparatus for Providing Cross-Benefits Based on a Customer Activity” and filed Mar. 31, 1999; U.S. patent application Ser. No. 09/274,281 entitled “Method and Apparatus for Providing Cross-Benefits via a Central Authority” and filed Mar. 22, 1999; U.S. patent application Ser. No. 09/322,351 entitled “Method and Apparatus for Providing Cross Benefits and Penalties” and filed May 28, 1999; U.S. patent application Ser. No. 09/100,684 entitled “Billing Statement Customer Acquisition System” and filed May 19, 1999, which is a continuation-in-part of U.S. patent application Ser. No. 08/982,149 entitled “Method and Apparatus for Printing a Billing Statement to Provide Supplementary Product Sales” and filed on Dec. 1, 1997; U.S. patent application Ser. No. 08/943,483 entitled “System and Method for Facilitating Acceptance of Conditional Purchase Offers (CPOs)” and filed on Oct. 3, 1997, which is a continuation-in-part of U.S. patent application Ser. No. 08/923,683 entitled “Conditional Purchase Offer (CPO) Management System For Packages” and filed Sep. 4, 1997, which is a continuation-in-part of U.S. patent application Ser. No. 08/889,319 entitled “Conditional Purchase Offer Management System” and filed Jul. 8, 1997, which is a continuation-in-part of U.S. patent application Ser. No. 08/707,660 entitled “Method and Apparatus for a Cryptographically Assisted Commercial Network System Designed to Facilitate Buyer-Driven Conditional Purchase Offers” filed on Sep. 4, 1996 and issued as U.S. Pat. No. 5,794,207 on Aug. 11, 1998; U.S. patent application Ser. No. 08/994,426 entitled “Method and Apparatus for Providing Supplementary Product Sales to a Customer at a Customer Terminal” filed on Dec. 19, 1997, which is a continuation-in-part of U.S. patent application Ser. No. 08/920,116 entitled “Method and System for Processing Supplementary Product Sales at a Point-of-Sale Terminal” and filed on Aug. 26, 1997; and U.S. patent application Ser. No. 09/221,099 entitled “Pre-Sale Data Broadcast System and Method” and filed Dec. 28, 1998. The entire contents of these application are incorporated by reference.

### FIELD

The present invention relates to transactions in which a customer purchases an item. In particular, the present invention relates to systems and methods wherein a third party subsidy and a merchant subsidy facilitate a transaction.

### BACKGROUND

Electronic commerce is becoming more accepted as a growing number of customers shop online (e.g., via the World Wide Web). However, electronic commerce suffers from many of the same problems that are associated with conventional commerce. For example, there is significant competition among merchants to attract and retain customers, and, as a result, merchants are not always able to increase profits by increasing prices. Price competition is even stronger on the Internet, where customers can more readily “shop around” to compare prices offered by different merchants.

Even when a customer has selected a particular merchant (e.g., the merchant offering the lowest item price), he or she may not complete a transaction (e.g., may not purchase an item) if an item price is greater than the customer is willing, or able, to pay. One way to encourage the customer to purchase the item, via the World Wide Web or otherwise, is to reduce the item price. Unfortunately, reducing the item price also reduces the merchant's profit, and the reduced profit may not be offset by an increase in sales.

Instead of directly reducing the item price, it is known that a merchant can offer a promotion to encourage the customer to purchase the item. For example, a merchant may advertise a “buy one get one free” promotion. Similarly, a merchant may advertise that customers can receive a discount when they establish a credit card account associated with the merchant.

It is also known that a number of merchants can work together to offer a promotion. For example, a first merchant may advertise that if a customer purchases a first item from the first merchant, a second item can be purchased at a reduced price from, or be given away by, a second merchant.

It is also known for a promotion to be generally provided at a point of sale. For example, a merchant's Web site may display a “banner advertisement” that allows a customer to access another Web site to make a second purchase.

All of the above techniques, however, have serious disadvantages. For example, traditional techniques for reducing an item price (e.g., by directly reducing the price or by offering a promotion) disclose a merchant's underlying price flexibility to the customer. That is, when a merchant offers a significant discount on the retail price of an item, customers may begin to feel that the item is worth much less than the retail price.

In addition, merchant promotions are offered to potential customers before the customer indicates that he or she is interested in a particular item (e.g., by advertising the promotion on a radio station). As a result, the merchant must pay to have information about the promotion distributed to many people who will not be interested in the promotion. Moreover, the merchant will not be able to use information associated with a particular transaction (e.g., demographic information about the customer) to select or modify the promotion as appropriate.

U.S. patent application Ser. No. 09/219,267 discloses a system wherein a merchant server of a first merchant receives an indication that a customer is interested in purchasing an item via a Web site. The indication may be, for example, a signal indicating that the customer is ready to “check out” a virtual shopping cart containing the item. In response, the merchant server provides an offer for a benefit from a second merchant, which may be referred to as one type of cross-benefit or subsidy offer. If the customer accepts the offer, the benefit is applied to the item being purchased. For example, the price paid for the item may be reduced, or the item may be provided to the customer for free. In exchange, the customer agrees to participate in a transaction with the second merchant. For example, the customer may agree to switch service providers (e.g., to switch long distance telephone service providers) or to initiate a new service agreement (e.g., to apply for a new credit card).

Even with such a subsidy offer system, however, a customer may still not complete a transaction. For example, consider a customer who indicates that he or she is interested in purchasing a $60 book (i.e., a book having an original retail price of $60) from a first merchant. If the maximum benefit available from a second merchant is $25, the customer still may not be willing to pay $35 for the book. That is, a customer who would be willing to accept the subsidy offer from the second merchant in exchange for receiving the book for free, or even for half of the original retail price, would still not complete the transaction. Similarly, a merchant may find that certain customers (e.g., customers under the age of thirty) are not likely to accept an offer to purchase an item associated with an original retail price of, for example, $200, for a reduced price of $110 (i.e., when the maximum benefit available from a second merchant is $90). Those same customers, however, may be more likely to accept an offer to purchase the item for a reduced price of $95.

A need exists, therefore, for further systems and methods for processing a transaction in which a customer purchases an item.

### SUMMARY OF THE INVENTION

The present invention introduces systems and methods wherein a third party subsidy and (i) a merchant subsidy and/or (ii) an additional task facilitate a transaction.

In one embodiment of the present invention, a third party subsidy offer to be provided to the customer is determined. The third party subsidy offer is associated with a third party benefit to be applied to the transaction. An evaluation may then be performed to determine if a merchant benefit will be applied to the transaction. In another embodiment an evaluation is performed to determine if an additional task will be applied to the transaction in addition to or instead of the merchant benefit.

Another embodiment of the present invention provides (i) means for determining a third party subsidy offer to be provided to the customer, the third party subsidy offer being associated with a third party benefit to be applied to the transaction, (ii) means for evaluating whether a merchant benefit will be applied to the transaction, and (iii) means for evaluating whether an additional task will be applied to the transaction.

With these and other advantages and features of the invention that will become hereinafter apparent, the nature of the invention may be more clearly understood by reference to the following detailed description of the invention, the appended claims and the several drawings attached herein.

### BRIEF DESCRIPTION OF THE DRAWINGS

FIG. 1A is a block diagram overview of a transaction system according to an embodiment of the present invention.

FIG. 1B is a block diagram overview of a transaction system according to another embodiment of the present invention.

FIG. 2 is a block schematic diagram of a merchant device according to an embodiment of the present invention.

FIG. 3 is a tabular representation of a portion of a customer database according to an embodiment of the present invention.

FIG. 4 is a tabular representation of a portion of an item database according to an embodiment of the present invention.

FIG. 5 is a tabular representation of a portion of a third party subsidy database according to an embodiment of the present invention.

FIG. 6A is a tabular representation of a portion of a merchant subsidy database according to an embodiment of the present invention.

FIG. 6B is a tabular representation of a portion of a merchant subsidy database according to an embodiment of the present invention.

FIG. 7 is a tabular representation of a portion of a transaction database according to an embodiment of the present invention.

FIG. 8 is a flow chart illustrating a method for processing a transaction according to an embodiment of the present invention.

FIGS. 9A and 9B are a flow chart illustrating a method for processing a transaction according to an embodiment of the present invention.

FIG. 10 is a flow chart illustrating a method for processing a transaction according to an embodiment of the present invention.

### DETAILED DESCRIPTION

The present invention is directed to systems and methods for processing a transaction in which a customer purchases an item. In particular, in one embodiment both a third party subsidy and a merchant subsidy may be used to facilitate the transaction. In another embodiment a third party subsidy and an additional task may be used to facilitate the transaction.

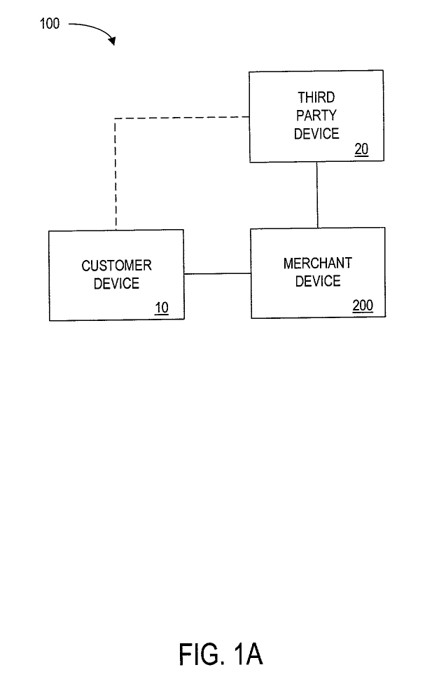

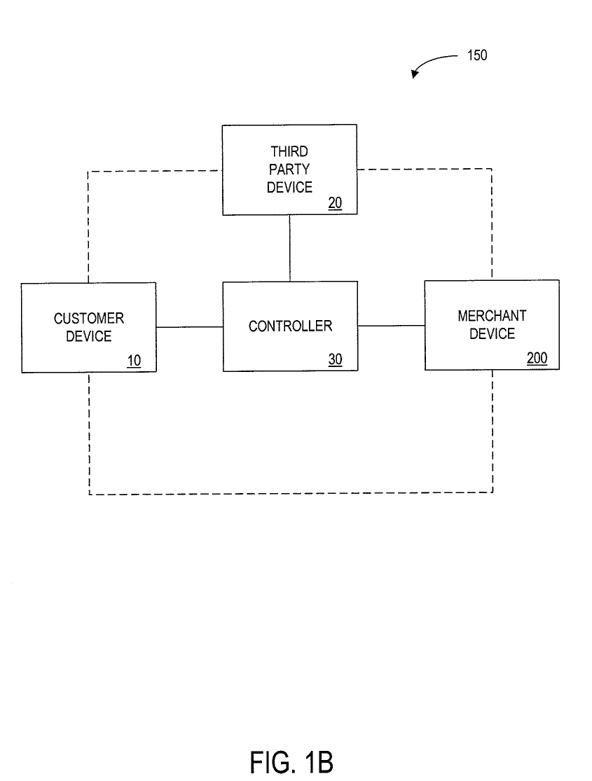

Turning now to the drawings, FIG. 1A is a block diagram overview of a transaction system 100 according to one embodiment of the present invention. The transaction system 100 includes a merchant device 200 in communication with a customer device 10 and a third party device 20. As used herein, devices (such as the customer device 10, the merchant device 200 and/or the third party device 20) may communicate, for example, via a communication network, such as a Local Area Network (LAN), a Metropolitan Area Network (MAN), a Wide Area Network (WAN), a Public Switched Telephone Network (PSTN), and/or an Internet Protocol (IP) network such as the Internet, an intranet or an extranet. Moreover, as used herein, communications include those enabled by wired or wireless technology. Note that although a single customer device 10 is shown in FIG. 1A, any number of customer devices 10 may be included in the transaction system 100. Similarly, any number of the other devices described herein may be included according to embodiments of the present invention.

In one embodiment of the present invention, the customer device 10 communicates with a remote, Web-based merchant device 200 (e.g., a Web server) via the Internet. Although some embodiments of the present invention are described with respect to information exchanged using a Web site, according to other embodiments information can instead be exchanged using, for example: a telephone, an Interactive Voice Response Unit (IVRU), a facsimile machine, postal mail, electronic mail, a WEBTV® interface, a cable network interface, a Point of Sale (POS) terminal, and/or a wireless communication system.

The customer device 10 may be, for example: a Personal Computer (PC), a portable computing device such as a Personal Digital Assistant (PDA), a wired or wireless telephone, a one-way or two-way pager, a kiosk, an Automated Teller Machine (ATM), or any other appropriate communication device. According to one embodiment, the customer device 10 is a POS terminal or a device located at, or in communication with, the POS terminal. In general, the customer device 10 may be any device capable of performing methods in accordance with the present invention.

Note that the customer device 10, the merchant device 200, and/or the third party device 20 may be incorporated in a single device (e.g., a kiosk located in the merchant's store).

As will be explained, the transaction system 100 may be used to process a transaction in which a customer purchases an item. As used herein, an “item” refers to anything that may be purchased by a customer (e.g., a good or a service). Airline tickets, consumer electronics and groceries are some examples of items that can be purchased by a customer.

According to an embodiment of the present invention, the merchant device 200 receives from the customer device 10 an indication that a customer is interested in purchasing an item. Consider, for example, a customer who accesses a Web site associated with a merchant. Upon the customer locating an item that he or she wishes to purchase, the customer may establish an indication of the item in a virtual shopping cart, thereby indicating an interest in purchasing an item.

According to an embodiment of the present invention, a third party subsidy offer is used to facilitate the transaction. As used herein, the “third party” refers to any party other than the customer and the merchant, and a third party “subsidy offer” refers to any offer associated with a benefit from a third party to be applied to the transaction. For example, a third party may offer to apply $50 towards the purchase of the item. In general, the benefit can be anything of value to the customer (e.g., an additional item, a higher quality item, an extended warranty, and/or a lower interest rate). Note that, according to one embodiment, a number of different third parties and/or third party subsidy offers are used to facilitate the transaction.

According to one embodiment, information about the transaction is used to determine the third party subsidy offer. The information about the transaction may include, for example, information associated with the customer, information associated with the item, information associated with the third party, and/or information associated with prior transactions. For example, when a customer indicates that he or she is interested in purchasing a television, the merchant device 200 may provide information about the transaction to the third party device 20. The third party device 20 can then evaluate the information and provide one or more appropriate subsidy offers (e.g., “subscribe to a satellite television service and receive the television you are interested in purchasing for free”) to the merchant device 200.

According to another embodiment, the merchant device 200 instead stores information received from one or more third party devices 20 (e.g., before a customer indicates that he or she is interested in purchasing an item). In this case, the merchant device 200 may determine an appropriate third party subsidy offer for the customer.

The third party subsidy offer may be transmitted from the merchant device 200 to the customer device 10. For example, the third party subsidy offer may be transmitted via a Web site or an electronic mail message. The customer device 10 may then transmit a response to the third party subsidy offer to the merchant device 200. If the response indicates that the customer accepts the third party subsidy offer, the benefit is applied to the transaction. For example, $50 may be applied towards the customer's purchase of the item.

The third party subsidy offer may be conditioned on the performance of a task by the customer. For example, a third party may offer to apply $50 towards the purchase of an airline ticket if the customer agrees to apply for a particular credit card account. In this case, a penalty may be applied if a customer who accepts the third party subsidy offer (e.g., receives the benefit) does not perform the task. For example, a customer may provide a credit card number when accepting a third party subsidy offer to have $50 applied towards the purchase of a television in exchange for subscribing to a cable television service for three months. If the customer stops using the service after two months, an appropriate penalty may be applied (e.g., a $33, $50 or $60 charge may be applied using his or her credit card number).

According to the present invention, a merchant subsidy is used in addition to the third party subsidy to facilitate the transaction. For example, a customer may indicate that he or she is interested in purchasing $100 worth of grocery items. The merchant device 200 may determine that a maximum of $45 worth of third party subsidy offers can be provided to the customer. The merchant, however, may want to offer the grocery items to the customer for free, or for half of the original retail price (e.g., because the customer may be much more likely to accept such an offer).

Thus, the merchant device 200 may perform an evaluation to determine if a merchant benefit, such as a merchant subsidy amount, will be applied to the transaction in addition to the third party subsidy. The evaluation may be based on, for example, the third party subsidy amount, a retail price associated with the item, a cost of the item to the merchant, a retail margin associated with the sale of the item at the retail price, a transaction volume associated with the merchant, and/or a minimum acceptable margin associated with the item. For example, the merchant device 200 may determine that the particular grocery items being purchased by the customer are associated with a cost of $80 to the merchant (e.g., the merchant had to pay $80 to one or more distributors in exchange for the grocery items). In this case, the merchant device 200 may decide that a $5 merchant subsidy will be used to facilitate the transaction in conjunction with the $45 third party subsidy. As a result, the grocery items can be provided to the customer at half of the original retail price (i.e., $50) if the customer accepts the offer. That is, the customer price (i.e., $50) plus the third party subsidy amount ($45) plus the merchant subsidy amount ($5) will equal the original retail price of the grocery items ($100).

According to an embodiment of the present invention, the particular third party subsidy amount and/or particular the merchant subsidy amount are not disclosed to the customer (e.g., the customer may simply be told “you can receive these grocery items for half of the original retail price if you apply for a new credit card today”). Such an embodiment may provide the merchant with increased flexibility when determining third party subsidy amounts and/or merchant subsidy amounts.

According to some embodiments of the present invention a task in addition to any tasks specified by the third party subsidy offer may be associated with the third party subsidy offer as a condition for obtaining the benefit specified in the third party subsidy offer. In such embodiments both the additional task and the third party subsidy offer may be output to the customer. The additional task may be output to the customer as if it were an integral part of the third party subsidy offer, such that it is not easily discemable to the customer that the task is not a condition specified by the third party as part of the third party subsidy offer. As discussed above, the third party subsidy offer may itself include a task as a condition to the customer's obtainment of the benefit specified by the third party subsidy offer. If the third party subsidy offer does specify a task, the additional task may be characterized as a further condition to the customer's obtainment of the benefit specified by the third party subsidy offer. Such an additional task may not be associated with any further benefit beyond that specified in the third party subsidy offer. Further, such an additional task may be sponsored by (i) the merchant, (ii) the third party that is sponsoring the third party subsidy offer, or (iii) another entity. The association of an additional task with a third party subsidy offer may be performed based on information associated with (i) the customer to whom the third party subsidy offer and additional task are to be output, (ii) an item included in the customer's purchase, (iii) the third party, (iv) the third party subsidy offer, and/or (v) any other information that is deemed relevant. For example, a task which requires the customer to answer a survey may only be associated with a third party subsidy offer if the offer is to be output to a customer that has not previously answered the survey.

FIG. 1B is a block diagram overview of a transaction system 150 according to another embodiment of the present invention. As shown in FIG. 1B, a controller 30 communicates with the customer device 10, the merchant device 200, and the third party device 20. For example, the controller 30 may receive an indication that a customer is interested in purchasing an item (e.g., by receiving the indication from the customer device 10 or the merchant device 200). The controller 30 may then evaluate information associated with the transaction, information associated with one or more subsidy providers (e.g., information received form one or more third party devices 20), and/or other information to determine a third party subsidy offer. For example, the controller 30 may receive a credit report from a credit reporting device (not shown in FIG. 1B) based on a credit card number associated with the customer. Moreover, the controller 30 may receive information about retail prices and item costs from the merchant device 200. Based on this information, the controller 30 may determine a merchant subsidy amount and transmit, for example, a combined offer (e.g., an offer including a third party subsidy and a merchant subsidy) to the customer device 10 or to the merchant device 200.

According to another embodiment, the controller 30 may only transmit information associated with the third party subsidy offer to the merchant device 200. The merchant device 200 would then determine the merchant subsidy and communicate with the customer device 10.

Note that a merchant subsidy may also be determined based on, for example, information stored at the customer device 10. For example, the controller 30 may store information associated with the customer at the customer device 10, such as by storing the information as a “cookie” at a customer's PC. A cookie may be a block of data that a Web server (e.g., the controller 30) stores on a client system (e.g., the customer device 10). When a customer returns to the same Web site, or an associated Web site, the browser of the customer device 10 sends a copy of the cookie back to the Web server. Cookies may be used to identify customers, to instruct the Web server to send a customized version of a Web page, to store subsidy information associated with the customer, and for other purposes. The merchant subsidy may also be based on, for example, information stored on a customer PDA or smart card, information stored at the controller 30, information stored at the merchant device 200 and/or information stored at the third party device 20.

Merchant Device

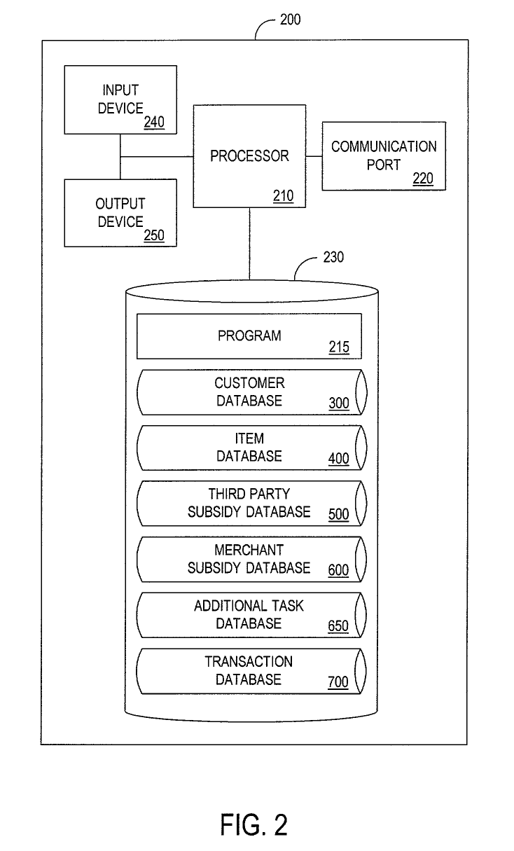

FIG. 2 illustrates a merchant device 200 that is descriptive of the device shown in FIGS. 1A and 1B, according to an embodiment of the present invention. The merchant device 200 comprises a processor 210, such as one or more INTEL Pentium® processors, coupled to a communication port 220 configured to communicate via a communication network (not shown in FIG. 2). The communication port 220 may be used to communicate, for example, with a number of customer devices 10, a number of third party devices 30, and/or a controller 30.

According to an embodiment of the present invention, the processor 210 may also be coupled to an input device 240, such as a keypad entry device used by a customer to enter information at a POS terminal. The processor 210 may also be coupled to an output device 250, such as a POS display used to provide an indication of a subsidy offer (e.g., an offer representing a third party subsidy and a merchant subsidy) to a customer.

The processor 210 is also in communication with a storage device 230. The storage device 230 may comprise any appropriate information storage device, including combinations of magnetic storage devices (e.g., magnetic tape and hard disk drives), optical storage devices, and semiconductor memory devices such as Random Access Memory (RAM) devices and Read Only Memory (ROM) devices.

The storage device 230 stores a program 215 for controlling the processor 210. The processor 210 performs instructions of the program 215, and thereby operates in accordance with the present invention. For example, the processor 210 may determine a third party subsidy offer to be provided to the customer, the third party subsidy offer being associated with a third party benefit to be applied to the transaction, and evaluate whether a merchant benefit will be applied to the transaction.

The program 215 may be stored in a compressed, uncompiled and/or encrypted format. The program 215 furthermore includes program elements such as an operating system, a database management system, and “device drivers” used by the processor 210 to interface with peripheral devices. Appropriate program elements are known to those skilled in the art.

Note that the processor 210 and the storage device 230 may be, for example, (i) located entirely within a single computer or other computing device or (ii) located in separate devices coupled through a communication channel. In one embodiment, the merchant device 200 comprises one or more computers that are connected to a remote database server.

As used herein, information may be “received” by or “transmitted” to, for example, (i) the merchant device 200 from a customer device 10 or a third party device 20 or (ii) a software application or module within the merchant device 200 from another software application, module or any other source.

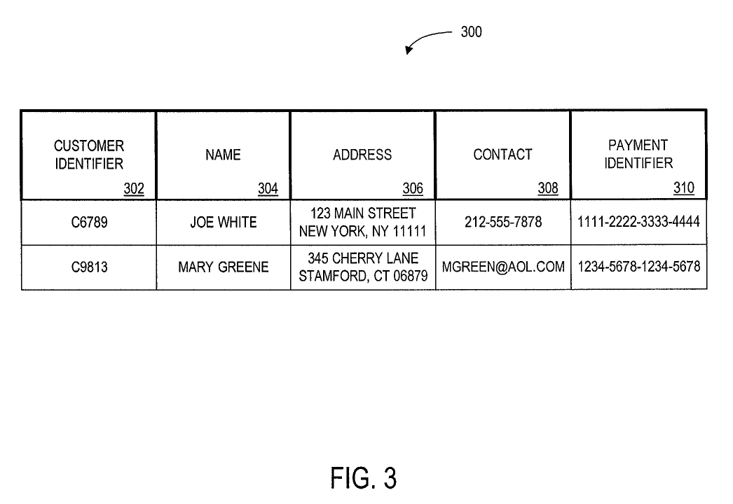

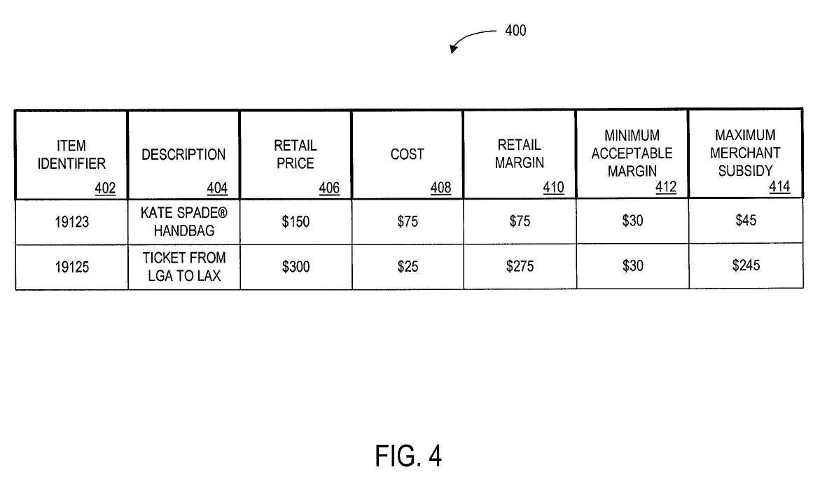

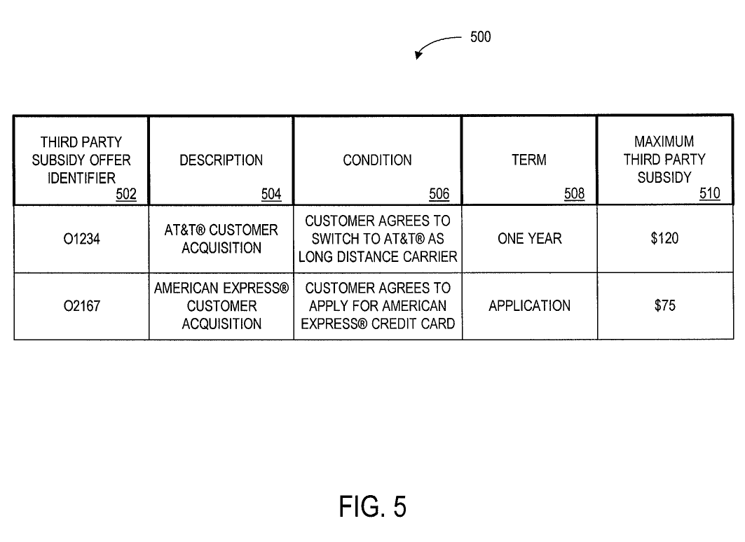

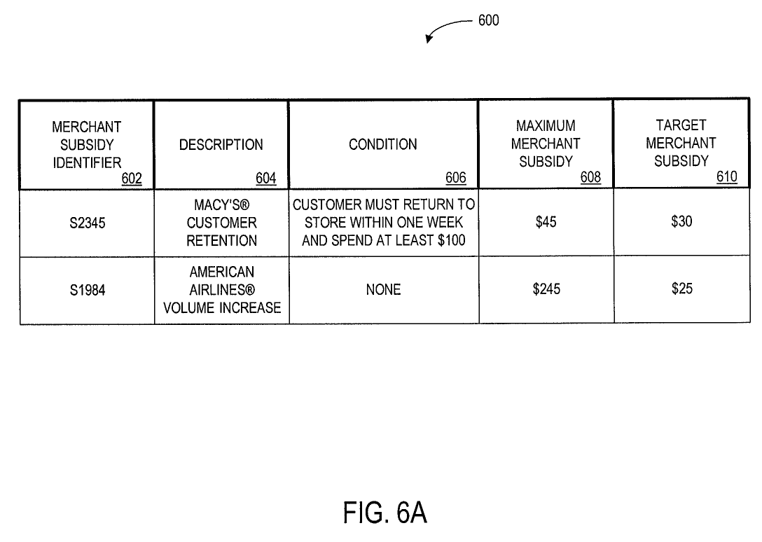

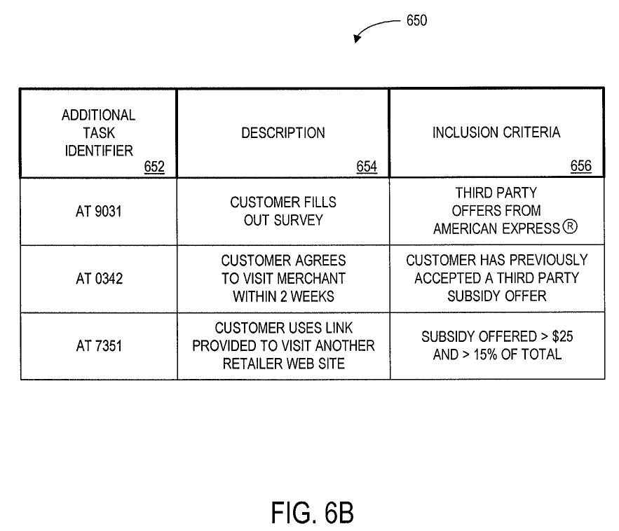

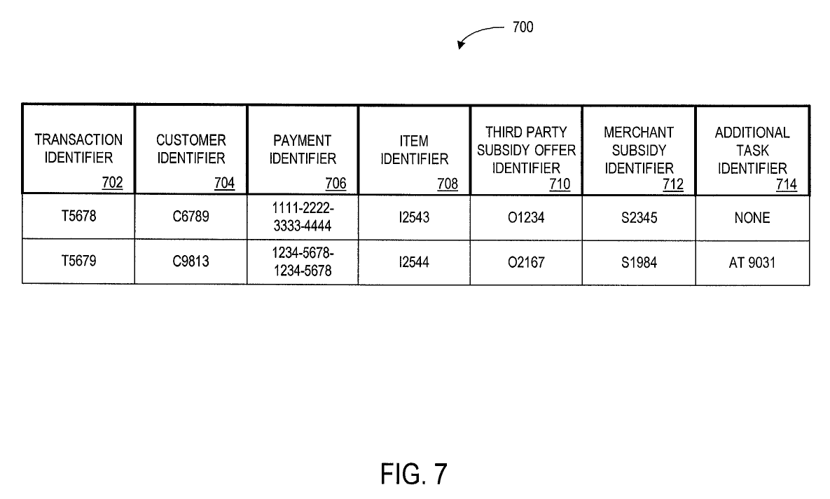

As shown in FIG. 2, the storage device 230 also stores: a customer database 300 (described with respect to FIG. 3); an item database 400 (described with respect to FIG. 4); a third party subsidy database 500 (described with respect to FIG. 5); a merchant subsidy database 600 (described with respect to FIG. 6); and a transaction database 700 (described with respect to FIG. 7).

Examples of databases that may be used in connection with the transaction systems 100, 150 will now be described in detail with respect to FIGS. 3 through 7. The schematic illustrations and accompanying descriptions of the databases presented herein are exemplary. Any number of other database arrangements may be used.

Customer Database

Referring to FIG. 3, a table represents the customer database 300 that may be stored at the merchant device 200, according to an embodiment of the present invention. According to another embodiment, some or all of the information in the customer database 300 is stored at the customer device 10 instead. The table includes entries identifying customers who may purchase an item from a merchant. The table also defines fields 302, 304,306, 308, 310 for each of the entries. The fields specify: a customer identifier 302; a name 304; an address 306; a contact 308; and a payment identifier 310. The information in the customer database 300 may be created and updated, for example, based on information received from a customer (e.g., received from a customer device 10 in conjunction with a customer registering with the merchant).

The customer identifier 302 may be, for example, an alphanumeric code associated with a customer who may purchase an item from a merchant. The customer identifier 302 may be generated, for example, by the merchant device 200 or by the customer (e.g., when a customer provides a user name and password). For each customer, the customer database 300 may also store the customer's name 304, the customer's address 306, and contact 308 information (e.g., a telephone number or electronic mail address) that may be used, for example, to provide an indication of a third party subsidy offer and a merchant subsidy to the customer.

The customer database 300 also stores the payment identifier 310 (e.g., a credit card account number, a debit card account number, a checking account number, or digital payment protocol information). The payment identifier 310 may be used, for example, to receive payment from the customer in exchange for an item and/or to apply a penalty to a customer if he or she does not perform a task associated with a subsidy offer (e.g., associated with a third party subsidy offer and/or a merchant subsidy offer).

Item Database

Referring to FIG. 4, a table represents the item database 400 that may be stored at the merchant device 200, according to an embodiment of the present invention. The table includes entries identifying items that may be sold to a customer. The table also defines fields 402, 404, 406, 408, 410, 412, 414 for each of the entries. The fields specify: an item identifier 402; a description 404; a retail price 406; a cost 408; a retail margin 410; a minimum acceptable margin 412; and a maximum merchant subsidy 414. The information in the item database 400 may be created and updated, for example, based on inventory information associated with a merchant.

The item identifier 402 may be, for example, an alphanumeric code associated with an item that may be sold to a customer. For each item, the item database 400 also stores the description 404 of the item. The description 404 may be, for example, any text, image, and/or audio information associated with the item.

The retail price 406 associated with the item may represent, for example, a price at which the merchant usually sells the item. The cost 408 of the item may represent, for example, an amount the merchant provides to a manufacturer or distributor in exchange for the item. The cost 408 may also represent, for example, any incremental cost to the merchant associated with providing a service to a customer. The retail margin 410 of the item may represent, for example, an amount of profit associated with the sale of the item at the retail price 406. According to one embodiment, the retail margin 410 may be based on the retail price 406 less the cost 408 of the item. Other information, such an overhead expense associated with an item (e.g., employee salaries, rent, and insurance), may also be used to determine the cost 408 and/or the retail margin 410 associated with an item.

By way of example, a merchant may typically sell a KATE SPADE® handbag to a customer for $150 as shown by the retail price 406 in the first entry of FIG. 4. If, for example, the merchant must pay $75 to the manufacturer for each handbag (as shown by the cost 408), then the merchant may realize a profit of $75 for each handbag that is sold (as shown by the retail margin 410).

The item database 400 may also indicate the minimum acceptable margin 412 for each item sold by the merchant. The minimum acceptable margin 412 may represent, for example, the minimum amount of profit that the merchant is willing to accept when the item is sold to a customer. The maximum merchant subsidy 414 may represent a maximum amount the merchant is willing provide as a subsidy to facilitate a transaction. According to one embodiment, the maximum merchant subsidy 414 may be based on the retail margin 410 (e.g., the retail price 406 less the cost 408) less the minimum acceptable margin 412. In other words, the maximum merchant subsidy 414 may represent the retail price 406 less the cost 408 and further less the minimum acceptable margin 412 associated with the item.

For example, if the merchant is not willing to accept less than a $30 profit when a handbag is sold (as shown by the minimum acceptable margin 412 associated with the first entry in FIG. 4), the merchant can provide a merchant subsidy of up to $45 to a customer to facilitate a transaction (as shown by the maximum merchant subsidy 414). That is, if each handbag costs $75 and the merchant is willing to accept a $30 profit, the merchant may provide a merchant subsidy of up to $45 towards a retail price of $150. In this case, when a merchant subsidy of $45 is provided, the merchant will realize an amount of profit equal to the retail price 406 less the cost 408 and further less the merchant subsidy (i.e., $150-$75-$45), or $30.

Third Party Subsidy Database

Referring to FIG. 5, a table represents the third party subsidy database 500 that may be stored at the merchant device 200, according to an embodiment of the present invention. The table includes entries identifying third party subsidy offers that may be used to facilitate a transaction. The table also defines fields 502, 504, 506, 508, 510 for each of the entries. The fields specify: a third party subsidy offer identifier 502; a description 504; a condition 506; a term 508; and a maximum third party subsidy 510. The information in the third party subsidy database 500 may be created and updated, for example, based on information received from the third party device 20.

The third party subsidy offer identifier 502 may be, for example, an alphanumeric code associated with a third party subsidy that may be used to facilitate a transaction. For each third party subsidy, the third party subsidy database 500 also stores the description 504 of the subsidy. The description 504 may be, for example, any text, image, and/or audio information associated with the third party subsidy.

The third party subsidy database 500 also stores the condition 506 and the term 508 associated with each third party subsidy. The condition 506 and the term 508 may represent, for example, one or more tasks that must be performed by the customer in exchange for the third party subsidy. The task may comprise, for example, providing information (e.g., answering survey questions), receiving information (e.g., viewing an advertisement), visiting a retail store associated with the third party (e.g., a predetermined number of times and/or within a predetermined period of time), purchasing another item associated with the third party, applying for or subscribing to a service, or promising to perform one or more tasks in the future. By way of example, the third party subsidy associated with the first entry shown in FIG. 5 will be provided to a customer who agrees to switch to AT&T® as his or her long distance carrier (as shown by the condition 506) for at least one year (as shown by the term 508). According to one embodiment, a penalty may be applied to a customer who does not perform a task associated with a third party subsidy offer. According to another embodiment, a third party subsidy is not associated with any task that must be performed by the customer.

According to still another embodiment, the third party subsidy database 500 may also store one or more evaluation rules (not shown in FIG. 5) associated with the third party subsidy. An evaluation rule may indicate, for example, that a particular third party subsidy will only be offered to customers over the age of forty who are interested in purchasing a particular book having a retail price 406 of no more than $20.

The third party subsidy database 500 also stores the maximum third party subsidy 510 that may be applied to facilitate a transaction. If the merchant wishes to reduce a retail price 406 associated with an item by more than the maximum third party subsidy 510, the merchant may evaluate whether a merchant subsidy will additionally be used to facilitate the transaction.

Merchant Subsidy Database

Referring to FIG. 6A, a table represents the merchant subsidy database 600 that may be stored at the merchant device 200, according to an embodiment of the present invention. The table includes entries identifying merchant subsidies that may be used to facilitate a transaction. The table also defines fields 602, 604, 606, 608, 610 for each of the entries. The fields specify: a merchant subsidy identifier 602; a description 604; a condition 606; a maximum merchant subsidy 608; and a target merchant subsidy 610. The information in the merchant subsidy database 600 may be created and updated, for example, based on revenue management information associated with a merchant (e.g., an amount of profit being earned, a total number of transactions being completed, item supply information, and/or item demand information).

The merchant subsidy identifier 602 may be, for example, an alphanumeric code associated with a merchant. For each merchant subsidy, the merchant subsidy database 600 also stores the description 604 associated with the merchant subsidy. The description 604 may be, for example, any text, image, and/or audio information associated with the merchant subsidy.

The merchant subsidy database 600 also stores the condition 606 associated with each merchant subsidy. The condition 606 may represent, for example, a task that must be performed by the customer in exchange for the merchant subsidy. The task may comprise, for example, providing information, receiving information, returning to the merchant's store (e.g., within a predetermined period of time and/or a predetermined number of times), making another purchase from the merchant (e.g., for a predetermined amount, a predetermined number of times, and/or within a predetermined period of time), and/or promising to perform one or more tasks in the future. By way of example, the benefit of the merchant subsidy associated with the first entry shown in FIG. 6A will be provided to a customer who agrees to return to MACY'S® within one week and spend at least $100. According to one embodiment, a penalty may be applied to a customer who does not perform a task associated with a merchant subsidy. According to another embodiment, a merchant subsidy is not associated with any task that must be performed by the customer.

Note that, according to one embodiment, the merchant subsidy database 600 may also store one or more evaluation rules (not shown in FIG. 6A) associated with the merchant subsidy. An evaluation rule may indicate, for example, that a particular merchant subsidy will only be offered to new customers.

The merchant subsidy database 600 also stores the maximum merchant subsidy 608 that may be used to facilitate a transaction. The maximum merchant subsidy 608 may represent, for example, a maximum amount a merchant is willing to provide to facilitate a transaction. Note that the maximum merchant subsidy 608 and/or the maximum merchant subsidy 414 stored in the item database 400 may represent, for example, maximum amounts associated with a particular item, a particular customer, a particular merchant store, a particular period of time (e.g., a weekly maximum), and/or a particular transaction.

The merchant subsidy database 600 also stores the target merchant subsidy 610 associated with each merchant subsidy. The target merchant subsidy 610 may represent, for example, an average amount the merchant may wish to provide to facilitate transactions. The target merchant subsidy 610 may be used, for example, when the merchant wishes to offer an item to a customer for free, where the maximum third party subsidy 510 plus the maximum merchant subsidy 608 is more than the retail price 406 associated with the item. In this case, the merchant may determine a merchant subsidy amount based on the target merchant subsidy 610 instead of the maximum merchant subsidy 608.

Thus, FIG. 6A depicts a database in which data is organized in a data structure in accordance with an embodiment of the present invention. The data structure includes a merchant subsidy data object (e.g., the merchant subsidy identifier 602) representing a subsidy that a merchant may apply to facilitate a transaction; a merchant subsidy condition data object (e.g., the condition 606) accessible from the merchant subsidy data object and representing a task to be performed by the customer in exchange for the subsidy; and a merchant subsidy amount data object (e.g., the maximum merchant subsidy 608 and/or the target merchant subsidy 610) accessible from the merchant subsidy data object and representing an amount of the subsidy.

Additional Tasks Database

Referring to FIG. 6B, a table represents the additional tasks database 650 that may be stored at the merchant device 200, according to an embodiment of the present invention. The table includes entries identifying additional tasks which may be added to a third party subsidy offer, according to an embodiment of the present invention. The table also defines fields 652, 654, and 656. The fields specify: an additional task identifier 652; a description 654; and inclusion criteria 656. The information in the additional tasks database 650 may be created or updated, for example, when a merchant receives or identifies an additional task that is beneficial to the merchant or when another entity submits a task to the merchant for inclusion in the additional tasks database 650. For example, a nearby merchant (or a merchant of another Web site, in an online embodiment) may submit a task that comprises a requirement that the customer visit the nearby merchant or the other merchant's Web site within a specified period of time. The entity that submits tasks for inclusion in the additional tasks database 650 may, in one embodiment, provide payment to the merchant for the privilege of including the task. Such payment may comprise, for example, (i) a flat fee, (ii) a fee calculated based on the number of times the task is output to the customer, (iii) a fee calculated based on the number of times a customer accepts a third party subsidy offer that includes the task, or (iv) a periodic fee during the duration the task is included in the additional tasks database 650.

The additional task identifier 652 may be, for example, an alphanumeric code associated with an additional task. The additional task identifier may uniquely identify the task. The additional task identifier may be generated or assigned to an additional task upon entry into the additional task database 650.

The description 654 may be a description of the task the customer is to perform. The task may comprise, for example, providing information (e.g. via a survey), receiving information (e.g. viewing advertisement or other marketing material), returning to the merchant's store or Web site (e.g. within a predetermined period of time and/or a predetermined number of times), visiting another merchant or entity, making a purchase (e.g. from the merchant outputting the offer or from another merchant), and/or trying a product (e.g. for free or on a trial basis). The task may be required to be performed immediately and/or at a time in the future. By way of example, a task may require a customer to fill out a questionnaire regarding the customer's purchasing habits or demographic data. The information stored in the description 654 may comprise the information, or one format of the information, that is output to a customer. The description 654 may thus include graphic and/or audio information to aid the customer's understanding of the task.

The additional tasks database 650 also stores the inclusion criteria 656 corresponding to each additional task. Inclusion criteria 656 indicates criteria for use in determining whether the corresponding additional task should be included with or in a third party subsidy offer output to a customer. The inclusion criteria may comprise criteria corresponding to information associated with (i) a customer; (ii) an item a customer is intending to purchase; (iii) a third party; (iv) a third party subsidy offer; and/or (v) any other relevant factor. By way of example, inclusion criteria may indicate that the corresponding additional task may be included with or in a third party offer (i) associated with a particular third party (e.g. American Express®) and/or (ii) that defines a benefit of a discount that meets a predefined threshold amount. Inclusion criteria 656 may be determined by (i) the entity that provides the additional task, (ii) the merchant, (iii) a third party with whose third party subsidy offer the additional task may potentially be associated with, or (iv) any combination thereof.

Additional tasks may be included with or in third party subsidy offers for a variety of reasons. One reason, for example, may be to make it less clear to a customer that is the recipient of a third party subsidy offer how much of the benefit defined by the third party subsidy offer is attributable to the third party. A third party subsidy provider may not wish to set expectations for a customer in future dealings with the third party subsidy provider. For example, a third party long-distance service company may be the sponsor of a third party subsidy offer that provides a customer with a benefit of $25.00 off a current purchase total in exchange for the customer's agreement to switch long distance service. In such an example the third party long-distance service company may be reluctant to have the customer associate the $25.00 as direct payment for switching the long distance service (e.g. because the customer or other customers may subsequently expect a payment of this magnitude for switching long distance service to this third party). In another example, a customer that is offered a benefit of $15.00 by car manufacturer or car dealer to test drive a car may come to expect payment of at least $15 each subsequent time he test drives a car from the dealer or manufacturer and may accordingly be reluctant to do this without payment.

It should be noted that a third party subsidy provider may also be reluctant to lower the amount of the benefit defined by the third party subsidy offer as a method of reducing customers' expectations for payment in future dealings with the third party subsidy provider. The third party subsidy provider may be reluctant to lower the benefit, e.g., because the acceptance rate by customers may be unacceptably decreased once the benefit is lowered. Adding an additional task (e.g. requiring the customer to return to the retailer within a certain period of time) to be included with the third party subsidy offer may cause the customer to not as readily associate the third party subsidy offer solely with the third party and accordingly lower the customer's expectations regarding future dealings with the third party subsidy provider. This may be especially likely if it is not clear to the customer whether or how much of the benefit corresponds to which required task (i.e. the task of switching long distance service and the task of returning to the retailer within a certain period of time).

Another reason for including an additional task in or with a third party subsidy offer may be, in the embodiment where the additional task is associated with the merchant, to promote the perception to a customer that the merchant is somehow contributing to the benefit. Although the merchant is contributing to the benefit by facilitating the customer's ability to receive benefits via third party subsidy offers, such a contribution may be too indirect to have an impact on the customer's goodwill towards the merchant. For example, if a customer shopping at merchant A is provided with a third party subsidy offer that offers the customer $25 off the current transaction in exchange for applying for a charge card account with American Express®, the customer may simply associate having received $25 with American Expressg. If, however, the above offer was output to the customer with the further condition that the customer return to merchant A within a week, the customer may associate having received $25 with both American Express® and merchant A. Further, the merchant need not incur any additional costs for more directly associating itself with the offer (e.g. the merchant need not contribute anything further to the benefit). Agreeing to allow the merchant to include additional tasks in or with third party subsidy offers may be at least part of the consideration furnished by a third party for allowing the third party to reach customers through the merchant.

Yet another reason for including additional tasks in or with third party subsidy offers is the revenue stream the merchant may acquire through such a practice. For example, an entity with limited funds such as, e.g., a non-profit organization, may not have the ability to provide a benefit to each customer for performing a task wherein the benefit is sufficient to induce the customer to agree to perform the task. However, the entity may have sufficient funds to pay the merchant for inclusion of the entity's tasks in or with third party subsidy offers.

By way of example, consider a local environmental organization that wishes to conduct a survey to determine the community's views on a particular environmental issue. Assuming the environmental organization only has $1,000 to spend on this survey and wishes to survey as many individuals as possible, it probably would not be effective to divide the $1,000 among a large number of customers and attempt to reach those customers by offering third party subsidy offers. For example, to reach 2,000 customers each customer would be paid a maximum of $0.50 (assuming no additional fees charged by the merchant for submitting third party subsidy offers into the system). It is unlikely that many customers would agree to answer survey questions for a benefit of $0.50. The merchant, however, may be willing to allow the environmental organization to submit the survey into the additional tasks database 650 as an additional task, for the payment of $1,000. This allows the environmental organization to reach thousands of individuals that are customers of the merchant without the need to provide a benefit to each individual. Further, since the merchant is capable of outputting third party subsidy offers to customers, it may not be overly burdensome to include another entity's additional task with or in a third party subsidy offer output to a customer. The merchant may substantially benefit from the revenue stream generated by accepting additional tasks into the additional tasks database 650 from such entities.

Transaction Database

Referring to FIG. 7, a table represents the transaction database 700 that may be stored at the merchant device 200, according to an embodiment of the present invention. The table includes entries identifying transactions in which customers purchase one or more items from a merchant. The table also defines fields 702, 704, 706, 708, 710, 712, 714 for each of the entries. The fields specify: a transaction identifier 702; a customer identifier 704; a payment identifier 706; an item identifier 708; a third party subsidy offer identifier 710; a merchant subsidy identifier 712; and an additional task identifier 714. The information in the transaction database 700 may be created and updated, for example, when a transaction is initiated or completed.

The transaction identifier 702 may be, for example, an alphanumeric code associated with a transaction between a merchant and a customer.

The customer identifier 704 may be, for example, an alphanumeric code representing the customer associated with the transaction (e.g., the customer purchasing an item from the merchant). The customer identifier 704 may also be based on, or associated with, the customer identifier 302 stored in the customer database 300. Similarly, the payment identifier 706 may be based on, or associated with, the payment identifier 310 stored in the customer database 300.

The item identifier 708 may be, for example, an alphanumeric code representing one or more items associated with the transaction (e.g., the item being purchased by the customer). The item identifier 708 may also be based on, or associated with, the item identifier 402 stored in the item database 400.

The third party subsidy offer identifier 710 may be, for example, an alphanumeric code representing a third party subsidy offer associated with the transaction (e.g., a third party subsidy offer that has been accepted by the customer). The third party subsidy offer identifier 710 may also be based on, or associated with, the third party subsidy offer identifier 502 stored in the third party subsidy database 500. The merchant subsidy identifier 712 may be, for example, an alphanumeric code representing a merchant subsidy associated with the transaction (e.g., a merchant subsidy applied to the transaction). The merchant subsidy identifier 712 may also be based on, or associated with, the merchant subsidy identifier 602 stored in the merchant subsidy database 600.

The additional tasks identifier 714 may be, for example, an alphanumeric code representing an additional task that was output to the customer as a condition for obtaining the benefit specified by the third party subsidy offer output during the transaction. The additional task identifier 714 may also be based on, or associated with, the merchant subsidy identifier 602 stored in the additional tasks database 650. The additional task identifier field 714 may store more than one additional task identifiers. For example, in one embodiment two or more additional tasks may be included in or with a third party subsidy offer output to a customer.

Thus, for each transaction the transaction database 700 stores information indicating the particular customer, the particular item, the third party subsidy, and the merchant subsidy associated with the transaction.

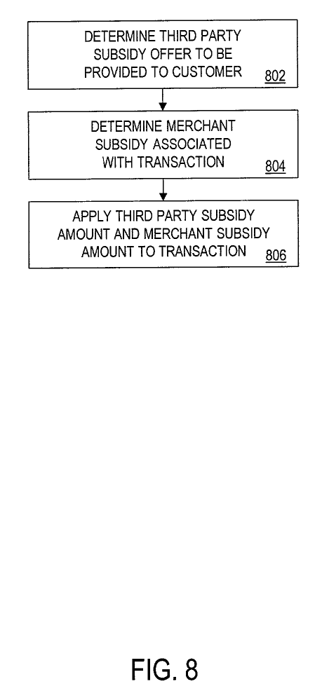

Methods that may be used in connection with the transaction system 100, 150 according to an embodiment of the present invention will now be described in detail with respect to FIGS. 8 through 10.

Transaction System Methods

FIG. 8 is a flow chart illustrating a method which may be performed, for example, by the merchant device 200 to facilitate a transaction, according to an embodiment of the present invention. The flow chart in FIG. 8, as well as the other flow charts discussed herein, does not imply a fixed order to the steps, and embodiments of the present invention can be practiced in any order that is practicable.

At 802, a third party subsidy offer to be provided to a customer is determined. The third party subsidy offer may be, for example, associated with a third party benefit to be applied to the transaction. For example, the third party benefit may comprise a third party subsidy amount (e.g., the maximum third party subsidy 510) that may be applied to a retail price 406 associated with the item. The third party subsidy offer may be determined based on, for example, information associated with the customer and/or information associated with the item. For example, new customers who are purchasing particular items (e.g., cameras) may be offered a particular third party subsidy (e.g., offered by a film developing service).

According to one embodiment, the third party subsidy offer is determined in response to the customer indicating that he or she is interested in purchasing an item (e.g., in response to a customer placing the item into his or her virtual shopping cart). The third party subsidy offer may be determined, based on information received in response to a request transmitted from the merchant device 200 to the third party device 20 after the customer indicates that he or she is interested in purchasing the item.

According to another embodiment, the third party subsidy offer is determined based on information received from the third party device 20 before the merchant device 200 receives an indication that the customer is interested in purchasing the item. For example, information about the third party subsidy offer may be retrieved from the third party subsidy database 500.

At 804, a merchant subsidy associated with the transaction may be determined. According to one embodiment, the merchant subsidy is determined in response to the customer indicating that he or she is interested in purchasing the item (e.g., in response to the customer accessing information associated with the item).

As part of the determining the merchant subsidy, the merchant device 200 may evaluate information associated with the transaction to decide if the merchant subsidy will be applied to the transaction. For example, information associated with the customer may be evaluated, such as a customer address (e.g., only customers in a particular geographic region may receive a merchant subsidy), demographic information, psychographic information, a credit rating, an association of the customer with the merchant (e.g., if the customer has recently registered with the merchant), an association of the customer with a merchant competitor, information associated with at least one previous transaction, a previous subsidy offer (i.e., a previous third party subsidy offer and/or merchant subsidy offer) provided to the customer, a previous subsidy offer accepted by the customer, and/or a previous subsidy offer rejected by the customer. By way of example, a merchant subsidy offer may only be provided to new customers over thirty-five years old who live more than five miles from the nearest merchant store.

Information associated with item may also be evaluated, such as an item category (e.g., large screen televisions), an item class (e.g., high quality items), an item feature (e.g., picture-in-picture capability), revenue management information, a number of transactions currently being completed by the merchant (e.g., on a per-day basis), an amount of profit currently being earned by the merchant, a supply of the item, and/or a demand for the item. Other information associated with the transaction (e.g., answers to survey questions, a time of day, and/or a time of year) may also be used to determine a merchant subsidy. For example, a customer who frequently accepts offers for half-price items may receive a different merchant subsidy as compared to a customer who usually only accepts offers for free items.

According to one embodiment, the merchant device 200 evaluates whether a merchant benefit will be applied to the transaction based on the maximum third party subsidy 510 and the retail price 406 associated with the item. Consider a merchant that wishes to offer an item to a customer for free (e.g., to increase the likelihood that the customer will accept the offer). In this case, if the maximum third party subsidy 510 is less than the retail price 406 associated with the item, then a merchant benefit (e.g., an amount based on the difference between the maximum third party subsidy 510 and the retail price 406) may be applied to the transaction. Similarly, a merchant benefit may be applied to the transaction if the maximum third party subsidy 510 is less than the cost 408 associated with the item (e.g., the merchant benefit amount may be based on the difference between the maximum third party subsidy 510 and the cost 408).

The merchant subsidy may also be based on, for example, the retail margin 410 associated with the item. For example, the merchant device 200 may apply a merchant subsidy if the retail margin 410 (e.g., the retail price 406 less the cost 408) less the required merchant subsidy amount (e.g., the merchant subsidy amount required to offer the item to the customer for free) is at least equal to the minimum acceptable margin 412 associated with the item.

Instead of offering the item to the customer for free, the merchant may decide to offer the item to the customer at a reduced item price (e.g., half of the original retail price or $100 less than the lowest price available in a particular region). In this case, the evaluation of the merchant subsidy may comprise comparing the reduced item price, the maximum third party subsidy 510, and the cost of the item 408. The reduced item price may be, for example, applied to the transaction if a margin associated with the transaction (e.g., the maximum third party subsidy 510 plus the reduced item price less the cost 408 of the item) is at least equal to the minimum acceptable margin 412 associated with the item. According to another embodiment, the reduced item price is used in the transaction without being disclosed to the customer (e.g., when a number of different items are being purchased in the transaction).

According to another embodiment, the evaluation of the merchant subsidy may comprise comparing the reduced item price, the maximum third party subsidy 510 and a retail price 406 associated with the item. The reduced item price may be, for example, applied to the transaction if the reduced item price plus the maximum third party subsidy 510 is at least equal to the retail price 406.

According to one embodiment, the customer may offer to purchase an item in exchange for payment of a customer offer amount (e.g., associated with a binding offer and/or an auction bid). The customer offer amount may be, for example, a customer-defined price included as part of a binding offer, or a Conditional Purchase Offer (CPO). In this case, the merchant subsidy amount may be based on, for example, the maximum third party subsidy 510, the customer offer amount, the retail price 406 associated with the item, the cost 408 of the item to the merchant, and/or a minimum acceptable price associated with the item.

According to another embodiment, the merchant subsidy amount may be based on at least one other item being purchased by the customer in the transaction. For example, if the customer is purchasing two items, a retail margin 410 associated with one item may be used to determine a merchant benefit with respect to the other item. Similarly, the merchant benefit may be based on at least one prior transaction between the customer and the merchant. That is, a large margin earned by the merchant in a past transaction with a customer may be applied to a later transaction (e.g., a later transaction with that customer). According to one embodiment, the margin may also be applied to a transaction with another customer.

Note that the merchant benefit may comprise, for example, a maximum merchant subsidy 608 or a target merchant subsidy 610 that will be applied to the retail price 406 associated with the item. The amount of the merchant benefit may be based on, for example, the retail price 406 associated with the item less the maximum third party subsidy 510. The merchant benefit, however, could be any benefit that is applied to a transaction (e.g., an increased warranty scope, an extended warranty duration, and/or improved financing terms). The merchant benefit may also be a substitute item provided to the customer in place of the original item (e.g., a higher quality item) and/or a supplemental item provided to the customer in addition to the original item (e.g., an item peripheral). Note that a benefit may be applied immediately to the transaction or may be applied in any other way (e.g., by subsidizing one or more future payments or by reducing future fees owed by the customer). According to one embodiment, the merchant subsidy is associated with a task that must be performed by the customer in exchange for the benefit.

A merchant subsidy offer may be transmitted from the merchant device 200 to the customer device 10 via, for example, a Web page, a telephone, an IVRU, a POS terminal, an ATM device, a PDA, a portable customer device, an electronic mail message, and/or a kiosk. Note that if the indication that the customer is interested in purchasing the item was received via a communication network, the merchant subsidy offer may be transmitted via the same communication network or via a different communication network. Similarly, a response (e.g., an acceptance of the merchant subsidy offer) may be received by the merchant device 200 from the customer device 10 via any appropriate communication network.

Examples of a task to be performed by the customer may include, for example, returning to the merchant within a predetermined period of time, purchasing another item from the merchant within a predetermined period of time, spending a predetermined amount of money via the merchant within a predetermined period of time, providing information to the merchant, receiving information from the merchant, and/or a promise to perform (or avoid) one or more tasks in the future. According to one embodiment, a penalty may be applied to a customer if he or she does not perform the task. For example, a penalty amount (e.g., based on a subsidy amount) may be applied using the customer's payment identifier 310 and/or the customer may be prohibited from receiving offers and/or associated benefits (e.g., third party subsidies and/or merchant subsidies) for a predetermined period of time.

At 806, the third party subsidy amount and the merchant subsidy amount are applied to the transaction. In the case of a third party subsidy offer and/or merchant subsidy offer, the subsidy amounts may only be applied after the customer accepts the offer(s).

According to one embodiment, the particular third party subsidy amount and/or the particular merchant subsidy amount are not disclosed to the customer. For example, consider a customer who is interested in purchasing a television for $300. A cable television service provider may be willing to provide $270 to facilitate the transaction if the customer subscribes to a cable television service for two years, and the merchant may be willing to provide $30 to facilitate the transaction (e.g., because the television is associated with a cost 408 of $250 to the merchant). In this case, the merchant may transmit a message to the customer stating, “this $300 television is free if you sign up for a two-year cable television service package today.” A customer may be more likely to accept such an offer as compared to an offer to purchase the television for $30 (i.e., without a merchant subsidy).

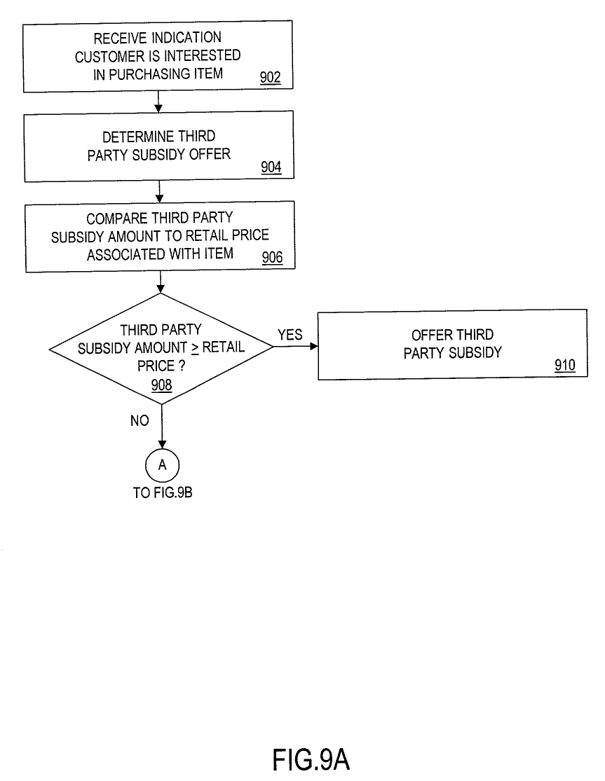

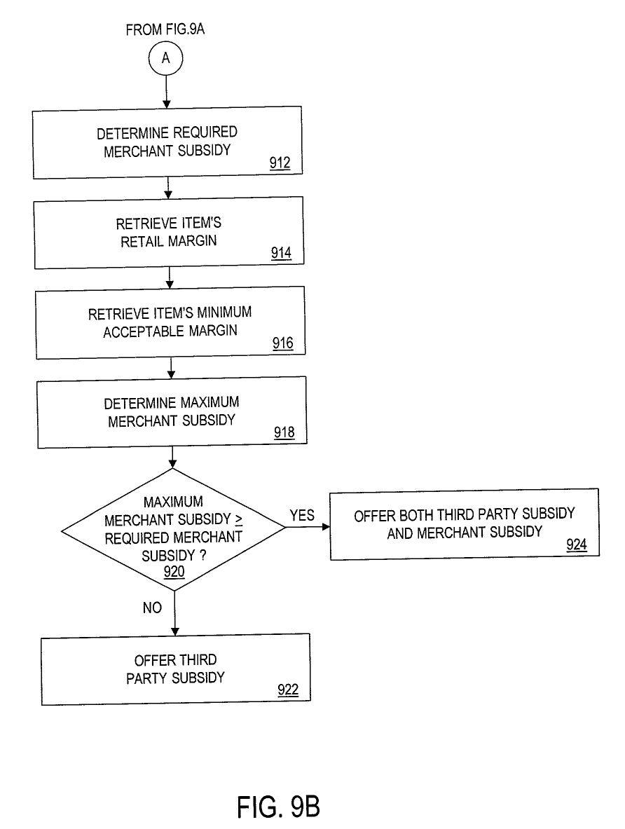

FIGS. 9A and 9B are a flow chart illustrating a method that may be performed, for example, by the merchant device 200 to facilitate a transaction, according to an embodiment of the present invention.

At 902, an indication that the customer is interested in purchasing the item is received. For example, an order for the item may be received from the customer via a communication network such as the Internet. Similarly, the indication may reflect that the customer is arranging to provide payment for the item (e.g., he or she is providing a credit card number). One system for receiving such an indication is disclosed in U.S. Pat. No. 5,960,411 entitled “Method and System for Placing a Purchase Order via a Communications Network.” According to one embodiment, the indication is received via a Web site when the customer “places” the item in his or her “virtual shopping cart.” According to another embodiment, the indication reflects that the customer has made an offer, including a customer defined price, for the item.

According to another embodiment, the indication may simply comprise the customer accessing information about the item. For example, the indication may be that the customer has viewed a Web page associated with the item for a predetermined period of time (e.g., thirty seconds).

According to another embodiment, the indication may comprise a signal from an input device associated with the customer. For example, the customer may move a mouse pointer onto an image of the item, or the customer may use an input device to scan a Universal Product Category (UPC) bar code associated with the item. As another example, a customer may use a keyboard to enter a search term (e.g., “televisions”) which acts as such an indication.

According to another embodiment, the indication that the customer is interested in purchasing the item may comprise retrieving information stored at a customer device, such as information stored at a customer's PDA.

According to another embodiment, an indication that the customer is no longer interested in purchasing the item may be used. For example, a customer may have arranged to purchase the item and subsequently cancel the order. Similarly, the indication may reflect that the customer is not going to purchase the item at an original price. Note, therefore, that an indication that the customer is not interested in purchasing the item at a particular time (e.g., because the current price is too high) may in fact comprise an indication that the customer may be interested in purchasing the item (e.g., if the price is lowered due to a subsidy being offered to the customer).

According to other embodiments, the indication may reflect that the customer is interested in purchasing another item or is purchasing the item from another merchant. For example, an indication by a customer that he or she is interested in purchasing a camera made by a first manufacturer may be an indication that the customer is also interested in purchasing a similar camera or peripheral made by a second manufacturer. Consider a customer who provides an indication to CIRCUIT CITY® that he or she is interested in purchasing a SONY(® television (for which no subsidy may be available). In this case, CIRCUIT CITY® may assume that the customer would also be interested in purchasing a PANASONIC® television (for which a subsidy is available).

In the case of an auction, the indication may comprise a bid for the item. According to another embodiment, the indication comprises an indication that a second customer is interested in purchasing the item. For example, consider a first customer who bids $50 to purchase a portable music player. The fact that a second customer bids $60 for that item may result in a subsidy offer (e.g., “perform this task and have $20 added to your bid”) being provided to the first customer.

At 904, a third party subsidy offer is determined. The third party subsidy offer may be determined, for example, based on information received from the third party device 20 (e.g., a customer identifier, a customer profile, an offer priority, a time of day, and/or a geographic location). At 906, an amount associated with the third party subsidy offer (e.g., the maximum third party subsidy 510) is compared to a retail price associated with the item. If the third party subsidy amount is at least equal to the retail price at 908, the third party subsidy is offered to the customer at 910 (e.g., the item may be offered to the customer for free and no merchant subsidy is required).

If the third party subsidy amount is less than the retail price at 908, a required merchant subsidy is determined at 912. For example, the required merchant subsidy may be the retail price less the maximum third party subsidy amount 510.

At 914 and 916, the retail margin 410 and the minimum acceptable margin 412 associated with the item are retrieved from the item database 400. The maximum merchant subsidy is then determined at 918. For example, the maximum merchant subsidy may be equal to the retail margin 410 less the minimum acceptable margin 412. Note that, according to one embodiment of the present invention, the maximum merchant subsidy is instead retrieved from the item database 400 (e.g., by retrieving the maximum merchant subsidy 414 from the item database 400).

If the maximum merchant subsidy is less than the required merchant subsidy at 920, only the third party subsidy is offered to the customer at 922.

If the maximum merchant subsidy is at least equal to the required merchant subsidy at 920, both the third party subsidy and the required merchant subsidy are offered to the customer at 924. Note that the third party subsidy and the merchant subsidy may be offered to the customer without revealing the exact third party subsidy amount and/or the exact merchant subsidy amount.

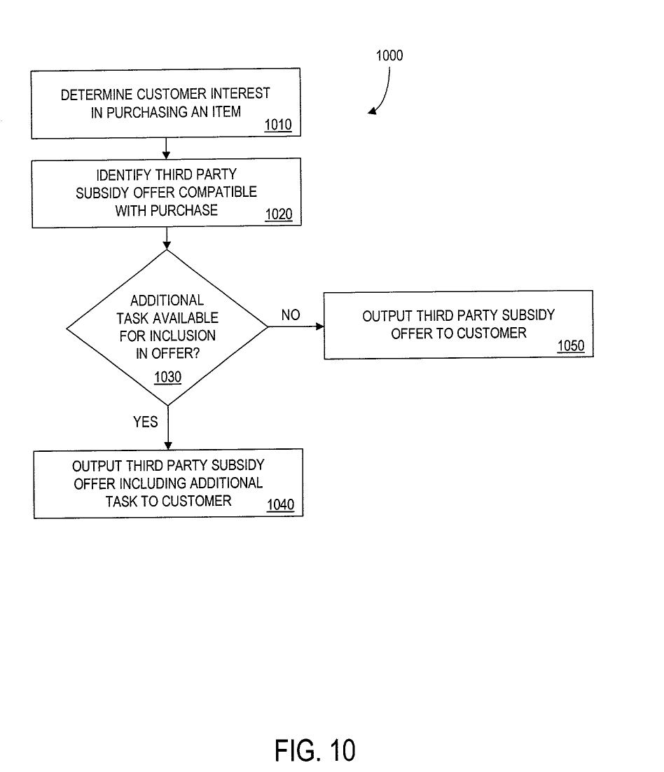

FIG. 10 is a flow chart illustrating a method that may be performed, for example, by the merchant device 200 (FIG. 1A) or by controller 30 (FIG. 1B) to facilitate a transaction, according to an embodiment of the present invention. FIG. 10 illustrates a method wherein it is determined whether an additional task is available for inclusion in a third party subsidy offer. The method of FIG. 10 may be performed, for example, at a time immediately before the output of the third party subsidy offer to a customer (e.g. as a customer is completing a transaction at a POS terminal).

At 1010 a customer interest in purchasing an item is determined. For example, an item identifier may be received at a POS terminal. Other means for determining a customer's interest in purchasing an item are described above with reference to FIG. 9A. At 1020 a third party subsidy that is compatible with the purchase is determined. For example, the third party subsidy database 500 may be searched for a compatible offer. Selection of a third party subsidy offer is described above with reference to FIG. 5.

At 1030 it is determined whether there is an additional task available for inclusion in or with the third party subsidy offer. By way of example, the additional tasks database 650 may be searched to determine whether any of the additional tasks stored therein specify selection criteria that are satisfied by the current purchase. If more than one additional task is determined to be available, (i) only one of the available additional tasks may be selected for inclusion in or with the third party subsidy offer; (ii) each of the available additional tasks may be selected for inclusion in or with the third party subsidy offer; or (iii) a subset of the available additional tasks may be selected for inclusion in or with the third party subsidy offer.

In the embodiment where only one of the available additional tasks is selected, the one available additional task may be selected, for example (i) on a random basis, (ii) based on which task appears first in the search results or that appears in the first found record of the database may be selected, (iii) based on which task is considered least burdensome to the customer, (iv) a preexisting association between a third party subsidy offer and an additional task, and/or (v) any other selection method deemed appropriate by the merchant or third party subsidy provider. In the embodiment where each of the available additional tasks may be selected in or with the third party subsidy offer the additional tasks may be presented to the customer such that (i) the customer's obtainment of the benefit specified by the third party subsidy offer is conditioned on each of the additional tasks being performed by the customer, or (ii) the customer's obtainment of the benefit specified by the third party subsidy offer is conditioned on one or more of the additional tasks being performed by the customer, wherein the customer chooses which one or more of the presented additional tasks to accept as a condition. For example, the customer may be required to select one or at least two of the additional tasks from the additional tasks presented in the offer. In an embodiment where a subset of the available additional tasks is presented to the customer, methods similar to those for selecting a single one of the additional tasks, described above, may be utilized. Further, as in the embodiment where each of the available additional tasks is selected for inclusion in or with the third party subsidy offer, the customer may be required to perform each of the additional tasks in the subset in order to obtain the benefit specified by the third party subsidy offer or may be allowed to select one or more of the additional tasks in the subset.

Selection criteria in addition to that stored in association with a particular additional task may be utilized to select an additional task. For example, selection criteria that apply to all of the additional tasks may be utilized. Examples of such criteria include (i) whether the customer has been the recipient of a particular task; (ii) whether the customer has previously accepted a particular task; and (iii) whether it is a particularly busy time at the merchant. The criteria of whether a merchant is particularly busy may be particularly relevant in embodiments where an offer for a third party subsidy offer (e.g., including an additional task) is output to a customer at a POS terminal. In such an embodiment the merchant may be concerned with processing each customer's transaction as quickly as possible and may thus select only third party subsidy offers and/or additional tasks that will requires a minimum amount of time to present to a customer. Alternatively a merchant may choose not to present third party subsidy offers (e.g. including an additional task) to customers at all during such busy times. A busy time at a merchant may be, for example, a time when (i) there is a particular number of customers within the merchant's store or waiting in line at a POS terminal; (ii) a particular number of transactions per unit of time being processed by the merchant; and/or (iii) a particular time of day, week, month, or year.

A probability of acceptance by the customer of an offer that includes the additional task with or in a particular third party subsidy offer may be identified and utilized in determining whether to output such an offer to a customer. A probability of acceptance may be determined based on, for example, a historical acceptance rate. For example, whether or not an offer comprising a particular third party subsidy offer and a particular additional task was accepted by a customer may be recorded each time an offer is output to a customer. Such records may be utilized to determine an acceptance rate for a particular third party subsidy offer-additional task combination. Alternatively, the acceptance rate for a particular third party subsidy offer combined with various additional tasks of varying levels of complexity and/or expected times for completion may be tracked. In such an embodiment a probability of acceptance for a particular third party subsidy offer-additional task combination may be determined by (i) determining the level of complexity or expected time for completion of the contemplated additional task, and (ii) determining what the historical acceptance rate for the third party subsidy offer was when it was combined with other additional tasks of comparable level of complexity and/or expected time for completion. It should be understood that the above-described methods of determining a probability of acceptance are meant as examples only and other methods for determining a probability of acceptance may be utilized.

General criteria similar to that described for selecting an additional task may also be utilized to select a third party subsidy offer from the third party subsidy database 500. Similar criteria may also be utilized to select a merchant subsidy from the merchant subsidy database 600.

In some embodiments the third party providing the third party subsidy offer with which an additional task is to be associated may provide input regarding what types of additional tasks are to be associated with the third party's offers. For example, the third party may specify that additional tasks below a particular level of complexity or expected time requirement for completion be associated with the third party's offers. A survey of five questions, for example, may be considered less complex or time consuming than a survey of ten questions. In such embodiments each additional task stored in additional tasks database 650 may have an indication of an estimated amount of time it will take a customer to complete the task or a relative level of complexity associated with a task. For example, a rating system may be employed wherein each additional task corresponds to a complexity rating. In another embodiment a third party may specify that an additional task (e.g. a particular additional task or any additional task) may be associated with the third party's subsidy offer only if the acceptance rate for the offer remains equal to or above a predetermined threshold.

Additional Embodiments

The following are several examples which illustrate various embodiments of the present invention. These examples do not constitute a definition of all possible embodiments, and those skilled in the art will understand that the present invention is applicable to many other embodiments. Further, although the following examples are briefly described for clarity, those skilled in the art will understand how to make any changes, if necessary, to the abovedescribed apparatus and methods to accommodate these and other embodiments and applications.

By way of example, consider a customer who registers with an online book merchant. During registration, the customer provides the merchant with demographic information and a credit card number. This information may be stored, for example, at the merchant device 200 or the customer device 10 (e.g., by using a cookie file). The customer then indicates that he or she wishes to purchase a $55 book from the merchant (e.g., by clicking on a “buy this book now” icon).

In response to the indication, the merchant evaluates the customer's demographic information, the original retail price of the book (i.e., $55) and the customer's credit card information. Based on the evaluation, the merchant determines that a credit card company will contribute $45 towards the transaction in the customer applies for a new credit card. Thus, based only on the third party (i.e., credit card company) subsidy, the book cannot be offered to the customer for free.

The merchant, however, also determines that the book is associated with a retail margin of $15 and a minimum acceptable margin of $5. The merchant decides to provide a $10 merchant subsidy to the transaction (which will still leave the merchant with a profit equal to the minimum acceptable margin of $5). The merchant then tells the customer that he or she can receive the book for free if he or she applies for a new credit card. The customer accepts the offer. Note that the customer may be required to complete an online credit card application at this point. The retailer then sends the book to the customer without charging the customer's credit card. In exchange for receiving the credit card application, the credit card company provides $45 to the online book merchant.

According to one embodiment of the present invention, the merchant may instead charge the customer $55 in exchange for the book. In this case, the credit card company may provide $55 directly to the customer and receive $10 from the merchant. Note that a party (e.g., the merchant or the credit card company) may instead provide multiple payments to the customer.

According to another embodiment, the subsidy offer is provided to the customer at a POS terminal. For example, a customer at a grocery store may be informed that he is eligible for $100 subsidy (which includes both a third party subsidy amount and a merchant subsidy amount) if he or she agrees to transfer a credit card balance to a particular credit card within two weeks. If the customer is not purchasing $100 worth of groceries during this transaction, the balance may be automatically applied to his next transaction. Similarly, a kiosk may be located in the grocery store and the customer can visit the kiosk to receive information about available subsidy offers.

According to another embodiment, a third party subsidy offer and/or merchant subsidy offer may require that the customer perform a number of tasks. For example, a customer may receive the following offer: “Receive this television for free if you: (i) apply for a new credit card, and (iii) purchase $50 worth of new items from this store using your new credit card.” In this case, both the credit card issuer and the merchant may contribute towards the subsidy received by the customer (i.e., the free television).

According to another embodiment, a customer may be a member of a “subsidy group.” The information associated with the group can then be used to determine the third party subsidy offers and merchant subsidies for the members. For example, a customer may indicate that he has been referred to a merchant by a friend (e.g., by providing an identifier associated with the friend). This information may be used to determine a merchant subsidy that will be provided to the customer and/or to the friend.

According to another embodiment of the present invention, the interactions between the customer and the merchant occur in person (and not via a communication network). For example, a employee (e.g., a salesperson) associated with the merchant may provide a combined third party subsidy offer and merchant subsidy to the customer.

Note that the customer device 10 may communicate directly with the third party device 20 (as shown by a dashed line in FIG. 1A). For example, the third party may offer to pay for the customer's purchase of a book if the customer applies for a new credit card. In this case, the credit card application information (e.g., the customer's name, address and Social Security number) may be transmitted directly from the customer device 10 to the third party device 20.

The third party device 20 may, according to one embodiment, transmit a redemption code the customer device 10. The customer device 10 can then transmit the redemption code to the merchant device 200 to receive the third party subsidy benefit. The redemption code may be, for example, a verifiable “hash” value generated when customer information is used in conjunction with a hash function, such as a one-way hash function. A hash function is a transformation that takes input information and returns a hash value. In general, one can think of a hash value as a “digital fingerprint” of the input information. For example, the input information to the hash function may be the customer's name and address and information about a task (e.g., a task identifier). In this case, the hash finction would generate the redemption code based on the input information. The merchant device 200 could then validate the redemption code using an appropriate function. Applicable hash functions and other encryption techniques are described in Bruce Schneier, “Applied Cryptography: Protocols, Algorithms, and Source Code in C” (John Wiley & Sons, Inc., 2nd Ed. 1996).

It should be noted that, rather than selecting an additional task to include in or with a third party subsidy offer at a time an indication of a customer's interest in purchasing an item is received, additional tasks may be selected and associated with third party subsidies at other times. The merchant device 200 (FIG. 1A) or controller 30 (FIG. 1B) may periodically (or non-periodically) analyze each third party subsidy offer and/or additional task available and determine which should be associated with one another. For example, an additional task may be analyzed and (e.g., based on the selection criteria corresponding to the task) be associated with one or more third party subsidy offers at the time the additional task is entered into the additional tasks database (or otherwise made available for use by merchant device 200 or controller 30). Accordingly, in one embodiment the additional tasks may be stored in the third party subsidy database 500 or the merchant subsidy database 600 as a condition for the customer's obtainment of the benefit specified by the third party subsidy offer with which the additional task is associated.

It should also be noted that one or more penalties may be assessed to a customer for not completing tasks the customer has agreed to perform. In an embodiment wherein the customer does not obtain the benefit of the third party subsidy offer until confirmation of completion of any tasks the customer agreed to when accepting the offer is received, the penalty may simply comprise withholding the benefit from the customer. In embodiments wherein the customer obtains the benefit of the third party subsidy offer at the time of accepting the third party subsidy offer, a penalty may comprise a charge or debit of a monetary amount to a financial account associated with the customer. Such a penalty may be communicated to the customer at the time the customer accepts the third party subsidy offer. In embodiments wherein the customer agrees to perform multiple tasks in exchange for a benefit, (i) a single penalty may be assess if the customer performs less than all of the tasks, (ii) a single penalty may be assessed if the customer performs less than a specified number or percentage of the specified tasks, (iii) multiple penalties may be assessed, one for each of the tasks not performed. A penalty may be assessed once a predetermined amount of time has passed since the customer's acceptance of the third party subsidy offer.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method comprising:
identifying a customer's interest in purchasing a product; and
outputting an offer to the customer,
wherein the offer comprises a benefit to be provided to the customer in exchange for the customer's agreement to perform a first task and a second task, and
wherein the first task and the benefit is associated with a first entity and the second task is associated with a second entity.

2. The method of claim 1, wherein the step of identifying a customer's interest comprises:
receiving a product identifier of a product the customer intends to purchase.

3. The method of claim 2, wherein the step of receiving comprises:
receiving a product identifier of a product the customer has provided to an operator of a point-of-sale terminal.

4. The method of claim 2, wherein the step of receiving comprises:
receiving a product identifier of a product the customer has placed in a virtual shopping basket.

5. The method of claim 1, wherein the step of outputting comprises:
outputting a prompt for the offer to an operator of a point-of-sale terminal, thereby prompting the operator to verbally present the offer to the customer.

6. The method of claim 1, wherein the step of outputting comprises:
displaying an indication of the offer to the customer at a point-of-purchase.

7. The method of claim 6, wherein the point-of-purchase comprises:
a point-of-sale terminal area.

8. The method of claim 6, wherein the point-of-purchase comprises:
a Web page of a Web site wherein the customer is expected to provide payment information for the product.

9. The method of claim 1, wherein the benefit comprises a monetary amount.

10. The method of claim 9, further comprising:
receiving, from the customer, an indication of acceptance of the offer.

11. The method of claim 10, further comprising:
applying the monetary amount to a purchase of the product by discounting a price of the product based on the monetary amount.

12. The method of claim 10, further comprising:
determining a performance of the first task and the second task by the customer; and
causing the monetary amount to be provided to the customer.

13. The method of claim 1, further comprising:
determining the benefit.

14. The method oflaim 13, further comprising:
determining a retail price of the product; and
wherein the step of determining the benefit comprises determining the benefit based on the retail price.

15. The step of cla im 13, wherein the step of determining the benefit based on the retail price comprises:
determining a value of the benefit such that the value does not exceed the retail price.

16. The method of claim 13,
wherein the first entity comprises a third party subsidy provider that is providing the benefit and the first task, and
wherein the second entity comprises an entity that is providing the second task and that is different from the first entity.

17. The method of claim 16, wherein the step of outputting comprises:
outputting the offer to the customer without revealing to the customer that the benefit is provided by the first entity and not the second entity.

18. The method of claim 1, wherein the step of outputting comprises:
outputting the offer to the customer after a time the customer indicates an interest in purchasing the item and before a time the customer provides payment for the item.

19. The method of claim 1, further comprising:
charging the first entity a monetary amount that is based on a value of the benefit; and
charging the second entity a monetary amount that is not based on the value of the benefit.

20. An apparatus, comprising:
a processor; and
a storage device capable of communicating with said processor and storing instructions adapted to be executed by said processor to:
perform the method of claim 1.

21. A medium storing instructions adapted to be executed by a processor to perform a method, said method comprising:
the method of claim 1.

22. A method comprising:
identifying a first offer for output to a customer, the first offer comprising a first benefit to be provided to the customer in exchange for the customer's commitment to perform a first task;
identifying a second task;
generating a second offer for output to the customer, the second offer comprising the first benefit to be provided to the customer in exchange for the customer's commitment to perform the first task and the second task; and
causing the second offer to be output to the customer.

23. The method of claim 22, wherein the first benefit comprises a discount off a purchase total associated with the customer.

24. The method of claim 22, wherein the first benefit comprises eligibility for a price that is below a retail price of the product.

25. The method of claim 22, wherein the second offer is output to the customer while the customer is consummating a transaction.

26. The method of claim 22, wherein the first task is associated with a first entity that is providing the first benefit and the second task is associated with a second entity that is not providing the first benefit.

27. The method of claim 22, wherein the second entity comprises a retailer at which the customer is consummating a transaction.

28. The method of claim 22, further comprising:
receiving an acceptance of the second offer from the customer.

29. The method of claim 28, further comprising:
providing the first benefit to the customer.

30. The method of claim 22:
wherein the first offer is sponsored by a third party subsidy provider such that the first benefit is sponsored by the third party subsidy provider; and
wherein the second task is sponsored by an entity that is different from the third party subsidy provider.

31. The method of claim 30, further comprising:
receiving, from the third party subsidy provider, a payment based on a value of the first benefit.

32. The method of claim 31, further comprising:
providing the benefit to the customer; and
wherein the step of receiving, from the third party subsidy provider, a payment comprises:
receiving, from the third party subsidy provider, a first payment as reimbursement for providing the benefit to the customer.

33. The method of claim 32, further comprising:
receiving, from the entity, a second payment.

34. The method of claim 30, further comprising:
receiving, from the entity, a payment.

35. The method of claim 34, wherein the step of receiving a payment comprises:
receiving, from the entity, a payment in exchange for outputting the second task to the customer.

36. The method of claim 34, wherein the step of receiving a payment comprises:
receiving, from the entity, a payment in exchange for storing the second task as available for output to the customer.

37. The method of claim 34:
wherein the step of receiving, from the entity, a payment is performed before the step of selecting the second task and before the step of outputting.

38. The method of claim 34, wherein the step of receiving a payment comprises
receiving, from the entity, a payment that is not based on a value of the first benefit.

39. The method of claim 30, further comprising:
determining a level of complexity of the second task; and
identifying the second task only if the level of complexity does not exceed a predetermined level of complexity.

40. The method of claim 39, wherein the predetermined level of complexity is a level of complexity identified by the third party subsidy provider.

41. The method of claim 30, further comprising:
determining an expected time for completion of the second task; and
identifying the second task only if the expected time for completion does not exceed a predetermined time.

42. The method of claim 41, wherein the predetermined time is a time identified by the third party subsidy provider.

43. The method of claim 30, further comprising:
determining a probability of acceptance of the second offer by the customer; and
outputting the second offer only if the probability of acceptance is at least a predetermined probability.

44. The method of claim 43, wherein the predetermined probability is a probability identified by the third party subsidy provider.

45. An apparatus, comprising:
a processor; and
a storage device capable of communicating with said processor and storing instructions adapted to be executed by said processor to:
perform the method of claim 22.

46. A medium storing instructions adapted to be executed by a processor to perform a method, said method comprising:
the method of claim 22.

47. A method comprising:
receiving an indication a customer is interested in purchasing an item from a merchant;
identifying a third party subsidy offer to be provided to the customer,
wherein the third party subsidy offer defines (i) a benefit to be applied to the transaction, and (ii) a first task to be performed by the customer, and
wherein the benefit is provided by a third party associated with the third party subsidy offer;
identifying a second task to be performed by the customer,
wherein the second task is a task provided by the merchant; and
causing an indication of the third party subsidy offer and the second task to be output to the customer,
wherein it is not revealed to the customer that the benefit is provided by the third party and not by the merchant.

48. The method of claim 47, further comprising:
receiving an indication of acceptance of the third party subsidy offer and the second task from the customer.

49. The method of claim 48, further comprising
causing the benefit to be provided to the customer in response to the step of receiving an indication of acceptance.

50. The method of claim 49, further comprising:
receiving an indication that the customer has performed the first task and the second task; and
causing the benefit to be provided to the customer in response to the step of receiving an indication that the customer has performed the task and the second task.

51. The method of claim 47, wherein the step of causing an indication comprises:
causing an indication of the third party subsidy offer and the second task to be output to the customer at a point-of-sale terminal.

52. The method of claim 47, wherein the second task is a task the performance of which will directly benefit the merchant.

53. The method of claim 52, wherein the second task is a requirement that the customer visit the merchant within a predetermined amount of time from the time of an acceptance of the offer.

54. An apparatus, comprising:
a processor; and
a storage device capable of communicating with said processor and storing instructions adapted to be executed by said processor to:
perform the method of claim 47.

55. A medium storing instructions adapted to be executed by a processor to perform a method, said method comprising:
the method of claim 47.

56. A method comprising:
receiving, from a first party, an offer to be provided to a customer, wherein the offer defines a task the customer is to perform in order to receive a first benefit defined by the offer;
receiving, from a second party, an indication of an additional task the customer is to perform, wherein there is no second benefit the customer is to receive in exchange for performing the second task;
modifying the offer to define both the task and the second task, wherein the customer is to perform both the task and the second task in order to receive the first benefit defined by the offer;
charging the first party a first monetary amount based on a value of the benefit;
charging the second party a second monetary amount;
outputting the modified offer to the customer without revealing that the second party is not contributing to the first benefit; and
providing the benefit to the customer if an acceptance of the modified offer is received from the customer.

57. An apparatus, comprising:
a processor; and
a storage device capable of communicating with said processor and storing instructions adapted to be executed by said processor to:
perform the method of claim 56.

58. A medium storing instructions adapted to be executed by a processor to perform a method, said method comprising:
the method of claim 56.

59. A method comprising:
providing, to a merchant, an indication of an offer to be output to a customer of the merchant,
wherein the offer defines a task to be performed by the customer in exchange and a benefit to be provided to the customer; and
providing, to the merchant, an agreement that at least one additional task associated with another entity may be included in the offer before the offer is output to the customer.

60. The method of claim 59, further comprising:
providing, to the merchant, at least one condition that the at least one additional task is to satisfy before being included in the offer.

61. The method of claim 60, wherein the at least one condition comprises a maximum complexity rating of the additional task.

62. The method of claim 60, wherein the at least one condition comprises a maximum expected time of completion of the additional task.

63. The method of claim 59, further comprising:
providing, to the merchant, a payment based on a value of the benefit to be provided to the customer.

64. An apparatus, comprising:
a processor; and
a storage device capable of communication with said processor and storing instructions adapted to be executed by said processor to:
perform the method of claim 59.

65. A medium storing instructions adapted to be executed by a processor to perform a method, said method comprising:
the method of claim 59.

66. A method comprising:
providing, to a merchant, an indication of an additional task to be included in an offer to be output to a customer,
wherein the offer defines a benefit to be provided to the customer in exchange for performing a task that is different from the additional task, and
wherein the offer is sponsored by a third party; and
providing, to the merchant, a payment in exchange for including the additional task in the offer.

67. The method of claim 66, wherein the payment is provided at a time the additional task is provided to the merchant.

68. The method of claim 66, wherein the payment is based on a number of offers the additional task is to be included in.

69. The method of claim 66, wherein the payment is provided at a time after the additional task is included in an offer output to a customer.

70. The method of claim 69, wherein the payment is based on a number of offers the additional task was included in.

71. An apparatus, comprising:
a processor; and
a storage device capable of communication with said processor and storing instructions adapted to be executed by said processor to:
perform the method of claim 66.

72. A medium storing instructions adapted to be executed by a processor to perform a method, said method comprising:
the method of claim 66.
